(19) United States
(12) Patent Application Publication
(10) Pub. No.: US 2021/0318416 A1
(43) Pub. Date: Oct. 14, 2021

(54) SENSOR AND SENSOR SYSTEM

(71) Applicant: TOYOTA JIDOSHA KABUSHIKI KAISHA, Toyota-shi (JP)

(72) Inventor: Takeshi YAMAKAWA, Atsugi-shi (JP)

(21) Appl. No.: 17/209,306

(22) Filed: Mar. 23, 2021

(30) Foreign Application Priority Data
Apr. 13, 2020 (JP) 2020-071706

(51) Int. Cl. G01S 7/481; G01S 17/931

(52) U.S. Cl. CPC G01S 7/4817; G01S 17/931

(57) ABSTRACT

A sensor includes: an emitter configured to scan a beam, as an observation wave, in a scanning direction while changing an emission direction of the beam by a predetermined angle; a controller programmed to control the emitter such that a beam width, which is an index indicating a spread of the beam in the scanning direction, is greater than the predetermined angle; and an estimator configured to estimate a representative point associated with a target object, from a plurality of observation points respectively corresponding to a plurality of the beams applied to the target object.

### CROSS-REFERENCE TO RELATED APPLICATIONS

This application is based upon and claims the benefit of priority of the prior Japanese Patent Application No. 2020-071706, filed on Apr. 13, 2020, the entire contents of which are incorporated herein by reference.

### BACKGROUND

### 1. Technical Field

Embodiments of the present disclosure relate to a sensor and a sensor system provided with the sensor.

### 2. Description of the Related Art

For this type of sensor, for example, a radar apparatus of a multi beam type has been proposed (refer to Japanese Patent Application Laid Open No. 2000-187071 (Patent Literature 1)).

In a technology/technique disclosed in the Patent Literature 1, a point that is the shortest in an X direction and a Y direction is determined on the basis of data on a position (xi, yi) of each channel CHi (i=1, 2, . . . , n) relating to an obstacle ahead of a vehicle equipped with the radar apparatus. Here, in the technology/technique disclosed in the Patent Literature 1, a value of the shortest X component is extracted from among a plurality of X components, and a value of the shortest Y component is extracted from among a plurality of Y components. Then, the position indicated by the value of the shortest X component and the value of the shortest Y component is considered a position of the obstacle ahead, for convenience. Therefore, as illustrated in FIG. 12 of the Patent Literature 1, there is a possibility that a position where the obstacle ahead is actually not present is specified as the position of the obstacle ahead.

In view of the problem described above, it is therefore an object of embodiments of the present disclosure to provide a sensor and a sensor system that are configured to improve an observation accuracy.

The above object of embodiments of the present disclosure can be achieved by a sensor including: an emitter configured to scan a beam, as an observation wave, in a scanning direction while changing an emission direction of the beam by a predetermined angle; a controller programmed to control the emitter such that a beam width, which is an index indicating a spread of the beam in the scanning direction, is greater than the predetermined angle; and an estimator configured to estimate a representative point associated with a target object, from a plurality of observation points respectively corresponding to a plurality of the beams applied to the target object.

The above object of embodiments of the present disclosure can be achieved by a sensor system including a first sensor, and a second sensor with higher angular resolution than that of the first sensor, wherein the second sensor includes: an emitter configured to scan a beam, as an observation wave, in a scanning direction while changing an emission direction of the beam by a predetermined angle; a controller programmed to control the emitter such that a beam width, which is an index indicating a spread of the beam in the scanning direction, is greater than the predetermined angle; and an estimator configured to estimate a representative point associated with a target object, from a plurality of observation points respectively corresponding to a plurality of the beams applied to the target object.

### Effect of Invention

According to the sensor and the sensor system, the emitter is controlled such that the beam width is greater than the predetermined angle. This makes it possible to increase the number of the observation points (in other words, the number of the beams) per unit area. As a result, the observation accuracy can be improved even in unsuitable cases for observation, such as, for example, when dirt is attached to a beam emitter of the sensor, when the target object is a low reflection object, and when the target object has a relatively small size.

### BRIEF DESCRIPTION OF THE DRAWINGS

Each of FIG. 1A and FIG. 1B is a diagram illustrating an example of a relationship between a beam width and a beam interval;

Each of FIG. 2A and FIG. 2B is a conceptual diagram illustrating a concept of resolution;

FIG. 3 is a block diagram illustrating a configuration of a sensor according to an embodiment;

FIG. 4 is a diagram illustrating an example of application of the sensor according to the embodiment; and

FIG. 5 is a block diagram illustrating a configuration of a sensor system according to an embodiment.

### DETAILED DESCRIPTION OF THE EMBODIMENTS

### <Sensor>

A sensor according to an embodiment will be described. The sensor according to the embodiment is provided with an emitter configured to scan a beam, as an observation wave, in a scanning direction while changing an emission direction of the beam (light, electromagnetic wave, etc.) by a predetermined angle. Here, the “beam” means an observation wave with relatively high directivity. A specific example of “beam” may include a light beam (i.e., a laser beam), a pencil beam, and the like. The predetermined angle may be a constant angle, or may be different for each scanning direction (for example, a predetermined angle at the time of horizontal scanning may be different from a predetermined angle at the time of vertical scanning).

The sensor includes a controller configured to control the emitter. The controller specifically controls the emitter such that a beam width, which is an index indicating a spread of the beam in the scanning direction, is greater than the predetermined angle.

The beam width may be represented by an angle (an angle of the beam spread, a directional angle, etc.) or may be represented by the width of a beam spot of the beam at a predetermined distance from the emitter (i.e., by a unit of distance). When the beam width is represented by the width of the beam spot at a predetermined distance from the emitter, a distance between the center of the beam spot of one beam at the predetermined distance from the emitter and the center of a beam spot of another beam emitted in a different direction from the one beam by the predetermined angle may be used as a value corresponding to the predetermined angle.

The sensor includes an estimator configured to estimate a representative point associated with a target object, from a plurality of observation points respectively corresponding to a plurality of the beams applied to the target object. The “observation point corresponding to the beam” means a reflection point at which the beam specified by observing a reflected wave of the beam is reflected. The observation point is not limited to a reflection point corresponding to a part of the target object, but may be a reflection point corresponding to a part of an object that is different from the target object. That is, a part of the plurality of beams applied to the target object may not be reflected by the target object, but may be reflected by an object that is different from the target object. Incidentally, there may be not only one but also two or more observation points corresponding to one beam.

Among the plurality of observation points, a plurality of observation points obtained by observing the reflected waves of the beams reflected by the target object are at similar distances from the sensor, and thus form a point group. The estimator estimates the representative point associated to the target object from the point group. The “representative point associated with the target object” may be, for example, a point corresponding to the center or the center of gravity of the target object, or the like. When the target object is an object with depth, the representative point may be a point corresponding to the center or the center of gravity of one surface of the target object, or the like. The existing various aspects can be applied to a method of estimating the representative point associated with the target object from the point group. For example, assuming that the point group is distributed according to a Gaussian distribution, the representative point associated with the target object may be estimated.

In order to improve the observation accuracy by the sensor, the resolution of the sensor is improved. At this time, for example, as illustrated in FIG. 1A, the beams are often narrowed down such that the beam spots do not overlap each other at a distance at which the observation target likely exists. In this case, as illustrated in FIG. 1A, a width w1 of the beam spot is less than a distance d between the centers of adjacent beam spots. Such a relationship is established when the beam width (i.e., the spread of the beam in the scanning direction) is less than the predetermined angle described above (here, 1 degree). The reason why the beam is narrowed down as illustrated in FIG. 1A when improving the resolution of the sensor is to avoid observing the same location for a plurality of beams, and that a method of recognizing the target object by obtaining one reflection point at one observation position is used.

According to such an observation method, for example, LiDAR (Light Detection and Ranging) can be realized in a relatively simple configuration. On the other hand, when the target is a low contrast object, a flat plate, or the like, or in an environment in which there are a strong reflection object and a low reflection object, there is a possibility of erroneous detection because it is hard to distinguish two adjacent objects or for similar reasons. Moreover, the beam is narrowed down to be relatively sharp. Thus, when dirt is attached to an optical window through which the beam passes in the sensor, the beam may be blocked by the dirt (i.e., observation performance of the sensor is significantly reduced) even if a part where the dirt is attached has a relatively small area.

In contrast, in the sensor according to the embodiment, as described above, the beam width emitted from the emitter is greater than the predetermined angle. In this case, for example, as illustrated in FIG. 1B, the beam spots overlap each other at a distance at which the observation target likely exists. In this case, as illustrated in FIG. 1B, a width w2 of the beam spot is greater than the distance d between the centers of adjacent beam spots. Since the beam relatively spreads out, even if some dirt is attached to the optical window, it is possible to prevent the beam from being blocked by the dirt.

Next, the resolution will be described with reference to FIG. 2A and FIG. 2B. The resolution of the sensor can be evaluated by the number of observation points per unit area (i.e., observation density). In both of the aspects illustrated FIG. 1A and FIG. 1B, the distance between the centers of adjacent beam spots is “d”. Therefore, the number of beams applied to a target object T illustrated in FIG. 2A and FIG. 2B is 16 in both cases (refer to FIG. 2A and FIG. 2B). That is, in any of the aspect illustrated in FIG. 1A and FIG. 1B, 16 observation points are obtained for the target object T. The resolution can be evaluated by the number of observation points per unit area, as described above. Therefore, it can be said that the resolution in the aspect illustrated in FIG. 1A is equivalent to the resolution in the aspect illustrated in FIG. 1B corresponding to the sensor according to the embodiment.

The resolution receives a higher evaluation as the number of observation points per unit area increases (in other words, with increasing observation density). Therefore, if the distance d is reduced, the observation density increases, and the resolution can be improved. Here, in the aspect illustrated in FIG. 1A, the distance d is set such that the beam spots do not overlap each other, and thus, the minimum value of the distance d is equal to the width w1. Therefore, in the aspect illustrated in FIG. 1A, the resolution is limited by the width w1. On the other hand, in the aspect illustrated in FIG. 1B corresponding to the sensor according to the embodiment, the distance d is less than the width w2. Therefore, in the sensor according to the embodiment, the resolution can be improved by reducing the distance d without being limited to the width w2.

Moreover, in the sensor according to the embodiment, since the beam emitted from the emitter relatively spreads out, one part of the target object T is irradiated with the beam a plurality of times when the target object T is observed by the sensor (refer to FIG. 2B). That is, the sensor is configured to perform multiple observations for the one part. In the sensor, a plurality of observation results are obtained for the same part (or the same target). Thus, even when the target is a low contrast object, a flat plate, or the like, or even in the environment in which there are a strong reflection object and a low reflection object, the sensor is allowed to appropriately observe the target while preventing the erroneous detection or preventing the target from being lost.

As described above, according to the sensor in the embodiment, the observation accuracy can be improved.

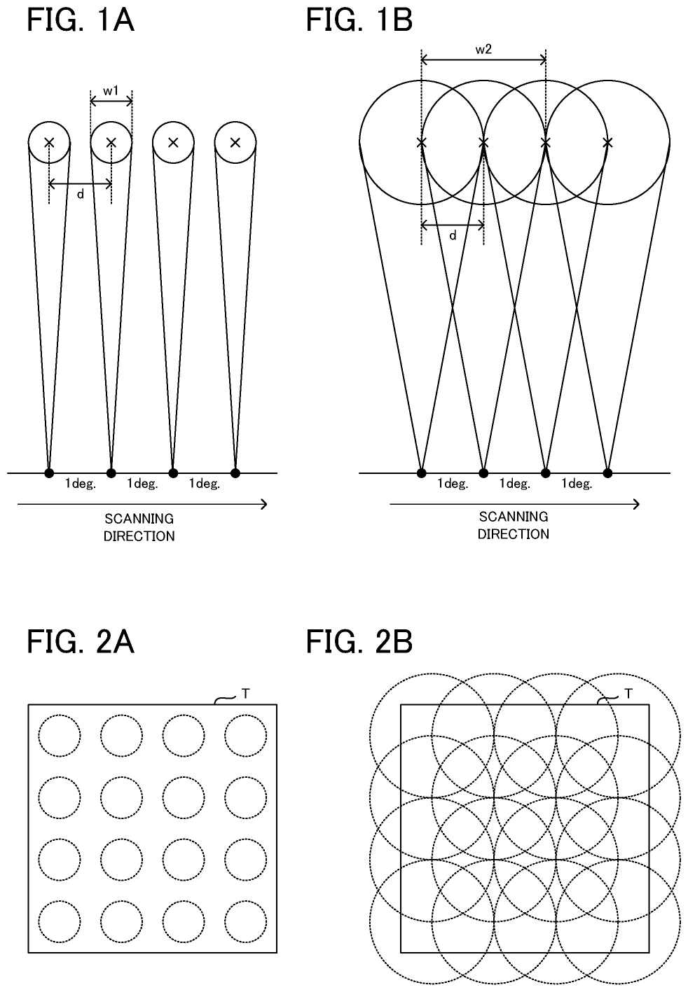

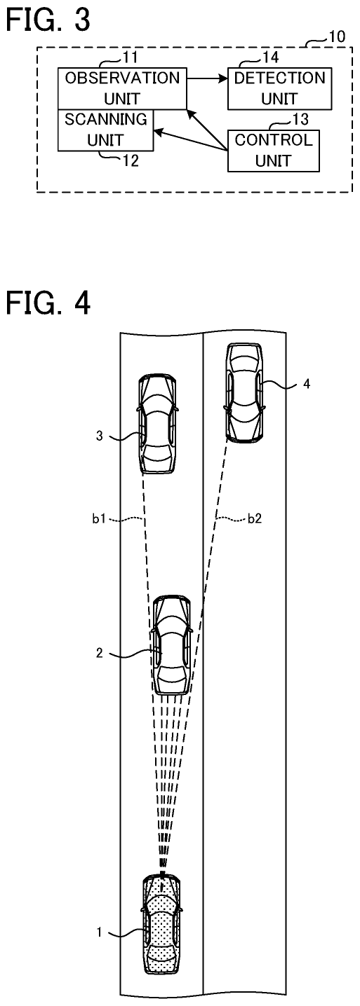

A sensor 10 as a specific example of the sensor according to the embodiment will be described with reference to FIG. 3 and FIG. 4. In FIG. 3, the sensor 10 is provided with an observation unit 11, a scanning unit 12, a control unit 13, and a detection unit 14.

The observation unit 11 emits a beam, and obtains observation information by receiving a reflected wave of the emitted beam. The scanning unit 12 scans the beam in a scanning direction while changing an emission direction of the beam emitted from the observation unit 11 by a predetermined angle. The scanning unit 12 may scan the beam emitted from the observation unit 11, for example, by rotating the observation unit 11 about a predetermined rotation axis, or may scan the beam, for example, by controlling the phase of the beam emitted from the observation unit 11 to change the emission direction of the beam.

The control unit 13 sets an observation parameter or the like associated with each of the observation unit 11 and the scanning unit 12. At this time, the control unit 13 especially sets the observation parameter such that the beam width of the beam emitted from the observation unit 11 is greater than the predetermined angle described above. The detection unit 14 receives the observation information from the observation unit 11, thereby, for example, to convert the observation information into a point group or an object target, or to identify an object. Especially, the detection unit 14 estimates a representative point associated with a target object, from a point group corresponding to an example of the plurality of observation points described above.

Even in the sensor 10, since the beam width of the beam emitted from the observation unit 11 is greater than the predetermined angle, the sensor 10 is allowed to improve the observation accuracy, as in the sensor according to the embodiment described above. Incidentally, “the observation unit 11” and “the scanning unit 12” correspond to an example of the “emitter” described above. The “control unit 13” and the “detection unit 14” respectively correspond to an example of the “controller” and the “estimator” described above.

Here, the sensor 10 used as an in-vehicle sensor will be exemplified, and additional advantages of the sensor 10 will be described with reference to FIG. 4 and the like. Suppose that the sensor 10 is mounted on a vehicle 1 in FIG. 4. Each of a plurality of dashed lines in FIG. 4 indicates a beam emitted from the sensor 10. In FIG. 4, a vehicle 2 is running ahead of the vehicle 1, and a vehicle 3 is running ahead of the vehicle 2. In addition, an oncoming vehicle 4 is running on an adjacent lane that is adjacent to a lane on which the vehicle 1 is running.

The beam width of the beam emitted from the sensor 10 is relatively wide. Here, when the beam width is relatively wide, for example, as illustrated in FIG. 2B, a part of the beam applied near an edge of the target object T is not reflected by the target object T, but is applied to a farther side of the target object T as viewed from an emission side of the beam. That is, when the vehicle 2 is irradiated with a beam b1 illustrated in FIG. 4, a part of the beam b1 is reflected by the vehicle 2 and another part of the beam b1 is applied, for example, to the vehicle 3. In the same manner, when the vehicle 2 is irradiated with a beam b2, a part of the beam b2 is reflected by the vehicle 2 and another part of the beam b2 is applied, for example, to the oncoming vehicle 4.

As a result, by the observation unit 11 receiving the reflected wave of the beam b1, the observation unit 11 is allowed to obtain information about an observation point (reflection point) associated with the vehicle 2 and information about an observation point associated with the vehicle 3, as the observation information. In the same manner, by the observation unit 11 receiving the reflected wave of the beam b2, the observation unit 11 is allowed to obtain information about the observation point associated with the vehicle 2 and information about an observation point associated with the oncoming vehicle 4, as the observation information.

That is, the sensor 10 is allowed to observe not only the reflected wave of the beam reflected by the target object (here, the vehicle 2), but also the reflected wave of the beam reflected by an object located on the farther side of the target object as viewed from the sensor 10. Therefore, a plurality of observation points respectively corresponding to a plurality of beams applied to the target object include a first type observation point, which is caused by that the beam is reflected on the target object, and a second type observation point (e.g., the observation points associated with the vehicle 3 and the oncoming vehicle 4), which is caused by the reflected wave generated by that the beam is reflected on the farther side of the target object as viewed from the emission side of the beam.

Here, reflection intensity when a part of the beam b1 is reflected by the vehicle 2 is clearly higher than that when another part of the beam b1 is reflected by the vehicle 3. In the same manner, reflection intensity when a part of the beam b2 is reflected by the vehicle 2 is clearly higher than that when another part of the beam b2 is reflected by the oncoming vehicle 4.

Thus, for example, when there are two observation points for one beam, the detection unit 14 may extract a part of the target object which is irradiated with one beam, as an edge of the target object, on condition that a difference in reflection intensity between the two is greater than a predetermined value.

The “predetermined value” may be set, for example, in consideration of an observation error associated with the sensor 10, a difference between the reflection intensity when a part of one beam is reflected by a part of the target object and the reflection intensity when another part of the one beam is reflected by another part of the target object that is on a farther side of the one part (i.e., an index for preventing the edge of the target object from being erroneously recognized when there is unevenness on a surface of the target object), and the like.

With this configuration, the detection unit 14 is allowed to extract one edge of the vehicle 2 on the basis of the difference in reflection intensity between the observation point of the vehicle 2 and the observation point of the vehicle 3 that are obtained by the irradiation of the beam b1. In the same manner, the detection unit 14 is allowed to extract another edge of the vehicle 2 on the basis of the difference in reflection intensity between the observation point of the vehicle 2 and the observation point of the facing vehicle 4 that are obtained by the irradiation of the beam b2. The detection unit 14 may further estimate a shape of the vehicle 2 (e.g., a shape of the vehicle 2 as viewed from the sensor 10, etc.) from a plurality of edges of the vehicle 2 extracted.

The sensor according to the embodiment is applicable to, for example, a LiDAR of a scanning type that emits a beam while mechanically changing an emission direction by a predetermined angle (corresponding to a scanning step angle), a LiDAR of a phased array type or a phased array radar in which a plurality of radiating elements each of which emits a beam are arranged in an array, or the like.

According to the sensor in the embodiment, a detection accuracy of a position of the target object can be also improved compared with a comparative example in which the beam width of the beam to be emitted is less than the predetermined angle. Especially when the target object is a low contrast object or in a bad environment, the sensor according to the embodiment has a high effect. That is, according to the sensor in the embodiment, not only the shape of the target object but also the position thereof can be accurately estimated.

### <Sensor System>

A sensor system according to an embodiment will be described. The sensor system according to the embodiment is provided with a first sensor, and a second sensor with higher angular resolution than that of the first sensor. Here, as long as the second sensor has higher angular resolution than that of the first sensor, the second sensor may be a sensor of the same type as the first sensor or may be a sensor of a different type from that of the first sensor. There may be not only one but also a plurality of first sensors. Moreover, there may be not only one but also a plurality of second sensors.

The resolution of the sensor is represented by the minimum distance or angle at which identification can be made by the sensor. As the minimum distance or angle that allows the identification is smaller, the resolution (i.e., an ability to identify a target) is higher. The “angular resolution” is an index that expresses the resolution by the minimum angle that allows the identification. The expression “higher angular resolution than that of the first sensor” means “the identification can be made to an angle that is less than the minimum angle at which the identification can be made by the first sensor”.

For example, in a sensor (e.g., a camera, etc.) that includes a detection unit with a plurality of detecting elements arranged in two dimensions and that temporarily observes a range of field of view of the detection unit, a viewing angle (i.e., instantaneous field of view) of one of the detecting elements corresponds to a specific example of the “angular resolution”. For example, in the case of a LiDAR as a specific example of a sensor that emits an observation wave (light, electric wave, etc.) and that observes a reflected wave of the emitted observation wave, if a distance to one surface is “x” and a distance between laser spots on the one surface is “d”, then, the “angular resolution” is expressed approximately by “d·2 tan⁻¹ (½x)” (this value corresponds to a scan step angle). In the case of a radar as another specific example of the sensor, the beam width expressed by angle corresponds to a specific example of the “angular resolution”.

The second sensor includes: an emitter configured to scan a beam, as an observation wave, in a scanning direction while changing an emission direction of the beam by a predetermined angle; a controller programmed to control the emitter such that a beam width, which is an index indicating a spread of the beam in the scanning direction, is greater than the predetermined angle; and an estimator configured to estimate a representative point associated with a target object, from a plurality of observation points respectively corresponding to a plurality of the beams applied to the target object. That is, the second sensor has the same configuration as the sensor according to the embodiment described above.

In the sensor system, the first and second sensors may operate in cooperation with each other. Specifically, for example, an object detected by the first sensor may be observed, highly accurately, by the second sensor with higher angular resolution than that of the first sensor. Since the sensor system includes the second sensor corresponding to the sensor according to the embodiment described above, the observation accuracy can be improved.

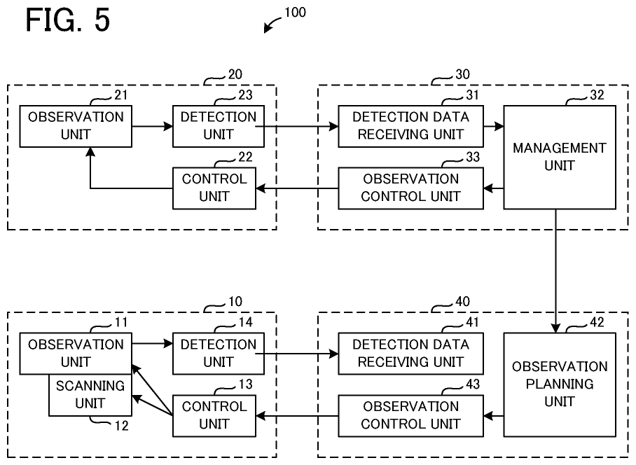

A sensor system 100 as a specific example of the sensor system according to the embodiment will be described with reference to FIG. 5. In FIG. 5, the sensor system 100 is provided with a sensor 10, a sensor 20, a data processing unit 30, and a data processing unit 40. Here, the sensor 20 corresponds to an example of the first sensor described above, and the sensor 10 corresponds to an example of the second sensor described above. A duplicated description of the sensor 10 will be omitted because it is the same as the sensor 10 described with reference to FIG. 3.

The sensor 20 includes an observation unit 21, a control unit 22 and a detection unit 23. The observation unit 21 obtains observation information. If the sensor 20 is, for example, a camera, then, the observation information may be an image, brightness value information, or the like. If the sensor 20 is, for example, a LiDAR, a radar or the like, then, the observation information may be information (e.g., distance, reflection intensity, etc.) obtained by that a reflected wave (e.g., light, electromagnetic wave, etc.) is received by the observation unit 21. The control unit 22 sets an observation parameter associated with the observation unit 21. The detection unit 23 receives the observation information from the observation unit 21, thereby, for example, to convert the observation information into a point group or an object target, or to identify an object. As a result of these processes, the detection unit 23 generates detection data.

A detection data receiving unit 31 of the data processing unit 30 receives the detection data from the detection unit 23. The detection data receiving unit 31 transmits the received detection data to a management unit 32. The management unit 32 stores therein the detection data. At this time, the management unit 32 may accumulate the detection data in chronological order on the basis of time point information given to the detection data.

The management unit 32 transmits, for example, the latest detection data out of the accumulated detection data, to an observation planning unit 42 of the data processing unit 40. Moreover, the management unit 32 transmits an instruction relating to an observation by the sensor 20 to an observation control unit 33. Incidentally, the specific contents of the instruction may be appropriately set depending on the purpose and application for which the sensor system 100 is used. The observation control unit 33 transmits information for the control unit 22 to set the observation parameter, to the control unit 22 in response to an instruction from the management unit 32.

The observation planning unit 42 of the data processing unit 40 determines, for example, an observation target of the sensor 10 on the basis of the detection data received from the management unit 32. When there are a plurality of observation targets, the observation planning unit 42 may set the observation order of the plurality of observation targets. The observation planning unit 42 generates an observation plan including information indicating the determined observation target, or the like. Then, the observation planning unit 42 transmits the generated observation plan to an observation control unit 43.

The observation control unit 43 transmits an instruction relating to an observation by the sensor 10 to the control unit 13, on the basis of the observation plan. Incidentally, the specific contents of the instruction may be appropriately set depending on the purpose and application for which the sensor system 100 is used. A detection data receiving unit 41 receives data from the detection unit 14. Specifically, the detection data receiving unit 41 receives as the data, for example, a representative point associated with the observation target estimated by the detection unit 14, a shape of the observation target estimated by the detection unit 14, and the like.

According to the sensor system in the embodiment, as in the sensor according to the embodiment described above, not only the shape of the target object but also the position thereof can be accurately estimated.

Various aspects of embodiments of the present disclosure derived from the embodiment explained above will be described hereinafter.

A sensor according to an aspect of the embodiments of the present disclosure includes: an emitter configured to scan a beam, as an observation wave, in a scanning direction while changing an emission direction of the beam by a predetermined angle; a controller programmed to control the emitter such that a beam width, which is an index indicating a spread of the beam in the scanning direction, is greater than the predetermined angle; and an estimator configured to estimate a representative point associated with a target object, from a plurality of observation points respectively corresponding to a plurality of the beams applied to the target object.

In an aspect of the sensor, the plurality of observation points include a first type observation point, which is caused by a reflected wave generated by that the beam is reflected on the target object, and a second type observation point, which is caused by a reflected wave generated by that the beam is reflected on a farther side of the target object as viewed from the emitter, and the emitter estimates a shape of the target object from the first type observation point and the second type observation point

A sensor system according to an aspect of the embodiments of the present disclosure includes: a first sensor, and a second sensor with higher angular resolution than that of the first sensor, wherein the second sensor includes: an emitter configured to scan a beam, as an observation wave, in a scanning direction while changing an emission direction of the beam by a predetermined angle; a controller programmed to control the emitter such that a beam width, which is an index indicating a spread of the beam in the scanning direction, is greater than the predetermined angle; and an estimator configured to estimate a representative point associated with a target object, from a plurality of observation points respectively corresponding to a plurality of the beams applied to the target object.

The present disclosure may be embodied in other specific forms without departing from the spirit or characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A sensor comprising:
an emitter configured to scan a beam, as an observation wave, in a scanning direction while changing an emission direction of the beam by a predetermined angle;
a controller programmed to control the emitter such that a beam width, which is an index indicating a spread of the beam in the scanning direction, is greater than the predetermined angle; and
an estimator configured to estimate a representative point associated with a target object, from a plurality of observation points respectively corresponding to a plurality of the beams applied to the target object.

2. The sensor according to claim 1, wherein
the plurality of observation points include a first type observation point, which is caused by a reflected wave generated by that the beam is reflected on the target object, and a second type observation point, which is caused by a reflected wave generated by that the beam is reflected on a farther side of the target object as viewed from the emitter, and
the estimator estimates a shape of the target object from the first type observation point and the second type observation point

3. A sensor system comprising:
a first sensor, and
a second sensor with higher angular resolution than that of the first sensor,
wherein the second sensor includes:
an emitter configured to scan a beam, as an observation wave, in a scanning direction while changing an emission direction of the beam by a predetermined angle;
a controller programmed to control the emitter such that a beam width, which is an index indicating a spread of the beam in the scanning direction, is greater than the predetermined angle; and
an estimator configured to estimate a representative point associated with a target object, from a plurality of observation points respectively corresponding to a plurality of the beams applied to the target object.
